(19) United States
(12) Patent Application Publication
(10) Pub. No.: US 2013/0249959 A1
(43) Pub. Date: Sep. 26, 2013

(54) PROJECTOR

(71) Applicants: Hideaki Umehara, Kanagawa (JP); Kiyoto Igarashi, Kanagawa (JP)

(72) Inventors: Hideaki Umehara, Kanagawa (JP); Kiyoto Igarashi, Kanagawa (JP)

(21) Appl. No.: 13/828,737

(22) Filed: Mar. 14, 2013

(30) Foreign Application Priority Data
Mar. 22, 2012 (JP) 2012-064895
Dec. 17, 2012 (JP) 2012-274518

(51) Int. Cl. G03B 21/16; G09G 5/00

(52) U.S. Cl. CPC G03B 21/16; G09G 5/003
USPC 345/690; 353/52

(57) ABSTRACT

A projector includes a projecting unit that generates an optical image by modulating light emitted from a light source according to image information and projects the optical image, and an illuminating unit that guides a part of the light emitted from the light source to a light diffusing plate with use of an optical member so as to diffuse the light at the light diffusing plate for illumination. The light diffusing plate includes a plurality of light diffusing members arranged with a gap interposed therebetween, and is mounted on an outlet that allows dissipation of heat generated in the projector.

### CROSS-REFERENCE TO RELATED APPLICATIONS

The present application claims priority to and incorporates by reference the entire contents of Japanese Patent Application No. 2012-064895 filed in Japan on Mar. 22, 2012 and Japanese Patent Application No. 2012-274518 filed in Japan on Dec. 17, 2012.

### BACKGROUND OF THE INVENTION

1. Field of the Invention

The present invention relates to a projector that projects an optical image based on image information onto a screen.

2. Description of the Related Art

A typical projector applies light emitted by a light source to an optical image forming panel formed of a plurality of panels arrayed in units of pixels. The light incident on each of the panels is reflected by or transmitted through a panel according to image information, so that the light is modulated into projection light for a dot image in units of pixels. The projection light for the dot image is magnified by a projector lens and is projected on a screen. If the screen is a reflective screen, the projected image can be viewed from the front side of the screen. If the screen is a transmissive screen, the projected image can be viewed from the back side of the screen.

The projector as described above projects an enlarged optical image onto a screen and enables a number of people to view the same image. Therefore, the projector is used in a conference or the like. However, when the projector is to be used in a conference, there is a difficulty in using the projector. Specifically, it is structurally difficult to project contents of a book or a document in a conference room or to project a face or a motion of fingers of a presenter onto the screen. A projector that deals with the low usability due to the limited usage and that may enhance the usage is disclosed in Japanese Patent No. 3497660. The projector disclosed in Japanese Patent No. 3497660 includes an illuminating unit that illuminates a subject, and an imaging unit that captures an image of the subject illuminated by the illuminating unit and outputs image data of the image. The illuminating unit uses a part of the light emitted by a light source for projection or uses light emitted by a light source for illumination that is separate from the light source for projection. The light from the illuminating unit is guided to a light diffusing plate mounted on an opening opened in a part of a device housing. Light diffused by the light diffusing plate illuminates contents of a book or a document, a face or a motion of fingers of a presenter, or participants of the conference. The imaging unit captures an illuminated subject and generates image data of the subject. An image based on the image data is projected on the screen. Therefore, it is possible to improve the usability and enhance the usage.

Furthermore, an enhanced use of the projector has been proposed. Specifically, the above-described projector is used in image display devices that display video images in video-conference devices installed at remote conference rooms and that transmit and receive video and voice to and from one another to perform a conference by connecting to a network. An example of the projector used in the video-conference device is disclosed in Japanese Patent Application Laid-open No. 2011-244080. The video-conference device disclosed in Japanese Patent Application Laid-open No. 2011-244080 illuminates an area that is spread in a direction opposite to a projection surface of the screen on which an optical image generated by the projector is projected. An imaging unit captures an illuminated subject and forms image data of the captured subject. A microphone forms voice data. A communicating unit connects to the network in a communication network and transmits the generated image data and voice data to the video-conference device at a remote place. The video-conference device at the remote place projects an optical image generated based on the image data received via the network onto the screen, and outputs the received voice data via a speaker. By using the projector as the imaging unit and the image display device of the video-conference device, the pattern of usage of the projector may be enhanced.

Incidentally, because the projector includes the light source for the projection, a drive circuit, and the like, heat is generated in the projector. In general, an outlet for dissipating the heat from the projector is opened in a part of the device housing. An air discharge plate for preventing a foreign matter from entering from the outside is mounted on the outlet. Besides, an opening for mounting the light diffusing plate of the illuminating unit is opened in a part of the outer side of the device housing as described above. Therefore, it is necessary to ensure a space for opening the outlet for mounting the air discharge plate and the opening for mounting the light diffusing plate in the device housing, resulting in an increase in the size of the device.

In particular, because the video-conference device disclosed in Japanese Patent Application Laid-open No. 2011-244080 includes the light source for the projection, the light source for the illumination, and drive circuits for the respective light sources, a large amount of heat is generated. Therefore, a further heat dissipation measure is needed. As the heat dissipation measure, it may be possible to provide a number of outlets or heat dissipation fans. However, because a number of components, such as the two light sources, the drive circuits for the respective light sources, and power sources are already mounted in the device, it is difficult to ensure a space for mounting a number of the outlets, the heat dissipation fans, and motors for driving the heat dissipation fans. If such a space is provided, the size of the entire device increases.

Therefore, there is a need to provide a projector that can reduce the size of the projector and ensure the heat dissipation effect.

### SUMMARY OF THE INVENTION

According to an embodiment, there is provided a projector that includes a projecting unit that generates an optical image by modulating light emitted from a light source according to image information and projects the optical image, and an illuminating unit that guides a part of the light emitted from the light source to a light diffusing plate with use of an optical member so as to diffuse the light at the light diffusing plate for illumination. The light diffusing plate includes a plurality of light diffusing members arranged with a gap interposed therebetween, and is mounted on an outlet that allows dissipation of heat generated in the projector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic perspective view illustrating a basic configuration of a projector;

FIG. 2 is a schematic cross-sectional view illustrating a configuration of a communication device provided with a projector function according to an embodiment;

FIG. 3A is a plan view illustrating an example of a configuration of a light diffusing plate;

FIG. 3B is a cross-sectional view taken along a line A-A′ in FIG. 3A;

FIG. 4A is a plan view illustrating another example of the configuration of the light diffusing plate;

FIG. 4B is a cross-sectional view taken along a line B-B′ in FIG. 4A;

FIG. 5A is a plan view illustrating still another example of the configuration of the light diffusing plate;

FIG. 5B is a cross-sectional view taken along a line C-C′ in FIG. 5B;

FIG. 6A is a plan view illustrating still another example of the configuration of the light diffusing plate;

FIG. 6B is a cross-sectional view taken along a line D-D′ in FIG. 6B;

FIG. 7 is a schematic cross-sectional view illustrating a modification of the configuration of the communication device provided with the projector function of the embodiment;

FIG. 8 is a schematic cross-sectional view illustrating the modification of the configuration of the communication device provided with the projector function of the embodiment;

FIG. 9 is a schematic cross-sectional view illustrating the configuration of the communication device according to the modification provided with the projector function of the embodiment;

FIG. 10 is a schematic diagram illustrating a manner of use of the projector according to the embodiment;

FIG. 11 is a block diagram illustrating a configuration of a video-conference device provided with the projector of the embodiment; and

FIG. 12 is a schematic diagram illustrating a conference system using the video-conference device.

### DETAILED DESCRIPTION OF THE PREFERRED EMBODIMENTS

First, a configuration of a general projector will be explained below.

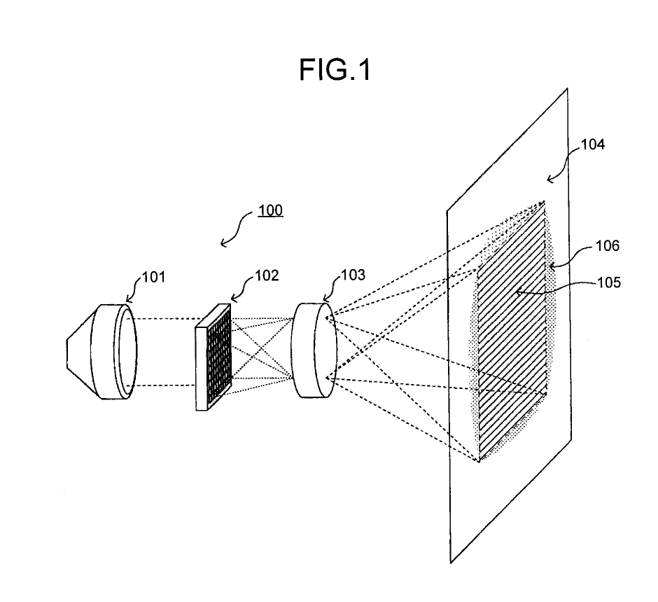

FIG. 1 is a schematic perspective view illustrating a basic configuration of a projector. In a projector 100 illustrated in FIG. 1, light emitted by a light source 101 for the projector reaches an optical image forming panel 102. The reached light is reflected by or transmitted through panels arrayed in units of pixels on the optical image forming panel 102 in accordance with image information, and is modulated into projection light for a dot image in units of pixels. The projection light for the dot image is projected on a screen 104 via a projector lens 103. In the projector 100 configured as described above, a free-form surface lens is usually used as the projector lens 103, and an optical image 105 formed by using light from the light source 101 and an optical image 106 formed without using the light are projected on the screen 104. The optical image 106 is based mainly on reflected light or diffused light reflected or diffused in the projector 100. The optical image 106 is independent of an image based on image information, in other words, is formed by unnecessary light. The optical image 106 makes the circumference of the optical image 105 brighter on the screen, and this causes blurring of the optical image 105 displayed on the screen. A subject is illuminated with light that is projected on the projector but that is not used for the optical image, in particular, the light that forms the optical image 106 in FIG. 1 or diffused light of the light source 101, which will be described in detail later.

A communication device provided with a projector function according to the embodiment will be explained below with reference to the drawings.

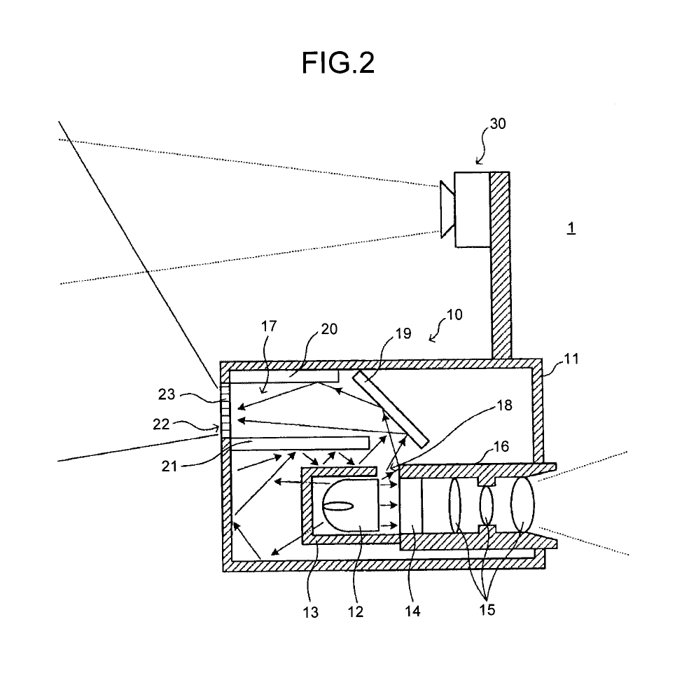

FIG. 2 is a schematic cross-sectional view illustrating a configuration of the communication device provided with the projector function according to the embodiment. A projector 1 in the communication device of the embodiment illustrated in FIG. 2 projects an enlarged image on a screen. The communication device according to the embodiment is used as a display device (an example of the communication device) for a video conference that is held by connecting, over a network, the communication device and another communication device connected to a display device including another projector at a remote place. The communication device according to the embodiment mainly includes a projector main-body 10, a camera main-body 30 that captures a participant of a conference for a video conference, a microphone 3, and a speaker 4. The projector main-body 10 includes, in a main housing 11, a light source housing 13 that houses a light source 12 for the projector and that substantially blocks light, and an optical member housing 16 that houses an optical image forming panel 14 and a projector lens 15. An opening 18 is arranged in a part of the light source housing 13 to guide light that is applied by the light source 12 but that is not used for image data toward an illumination light path 17.

The light that is applied by the light source 12 but is not used for image data is unnecessary light that forms the optical image 106 in FIG. 1 as described above. Meanwhile, the light source housing 13 cannot completely block light. Therefore, reflected light or diffused light of the light that is not used for the image data may leak from, for example, a connection section of a housing member of the light source housing 13. Furthermore, the light that is not used for the image data may transmit through the housing member. The reflected light, the diffused light, and the transmitted light are guided to the opening 18 by being reflected by a wall surface of the main housing 11, and thereafter are reflected by a reflector 19 and guided to the illumination light path 17. The light guided to the illumination light path 17 is reflected by reflectors 20 and 21 provided on inner surfaces of the illumination light path 17 and incident on a light diffusing plate 23 mounted on an outlet 22 in a part of the wall of the main housing 11. In the embodiment, the communication device that includes the projector 1 provided with an electronic camera 2, the microphone 3, and the speaker 4 is illustrated by way of example. However, the embodiment may simply be applied to a projector. Namely, the communication device does not necessarily have to include the electronic camera 2, the microphone 3, and the speaker 4. In the following, the projector will be mainly explained unless otherwise noted.

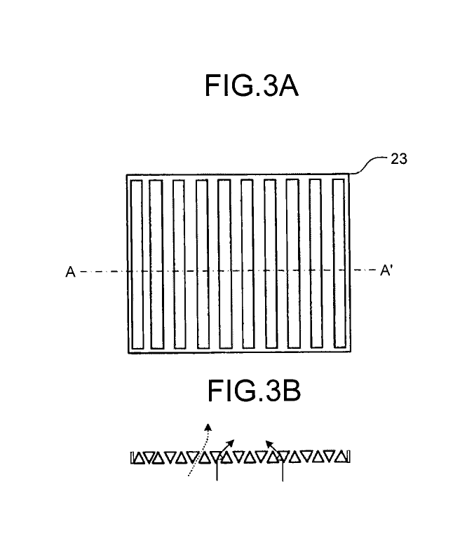

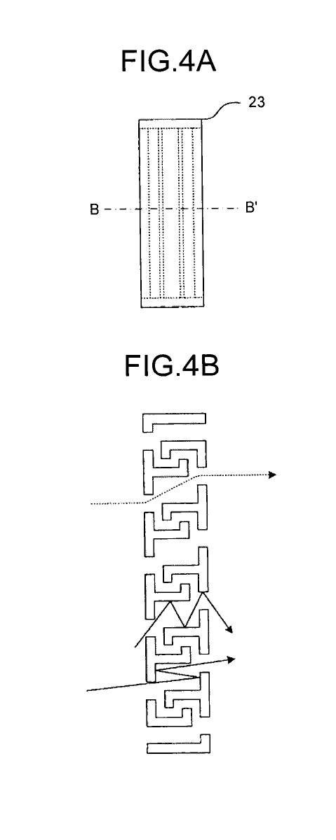

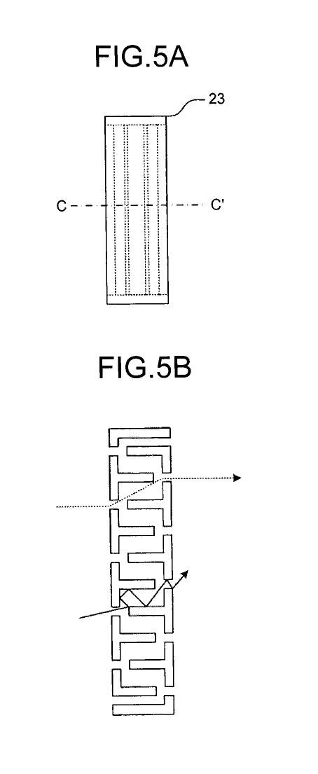

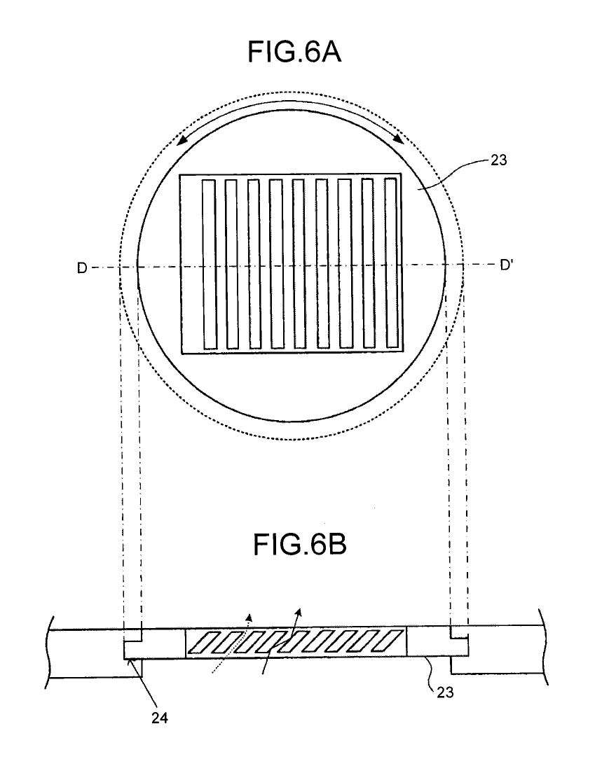

A plurality of light diffusing members with, for example, triangular cross-sections as illustrated in FIG. 3B, which is a cross-sectional view taken along a line A-A′ in FIG. 3A, are arrayed on the light diffusing plate 23. For another example, it may be possible to employ light diffusing members with approximately J-shaped cross-sections as illustrated in FIG. 4B, which is a cross-sectional view taken along a line B-B′ in FIG. 4A, or with T-shaped cross-sections as illustrated in FIG. 5B, which is a cross-sectional view taken along a line C-C′ in FIG. 5A. For still another example, it may be possible to use light diffusing members with parallelogram cross-sections as illustrated in FIG. 6B, which is a cross-sectional view taken along a line D-D′ in FIG. 6A. The light diffusing plates illustrated in FIG. 3A to FIG. 6B are configured so that the number of light diffusing surfaces can be increased. In each of the light diffusing plates illustrated in FIG. 3A to FIG. 6B, heat generated in the device is dissipated in a direction indicated by a dotted line illustrated in FIG. 3B, 4B, 5B, or 6B, and light is diffused and output in directions indicated by solid line arrows from the light diffusing plate by being reflected in the inner wall surfaces of the light diffusing members. If a gap between the light diffusing members is too large, a light diffusion function of the light diffusing plate may be reduced or a foreign matter may enter the light diffusing plate. Therefore, the gap is relatively narrowed. The light diffusing plate is formed as a plate by dispersion mixing of inorganic light diffusing agent, such as calcium carbonate, barium sulfate, titanium oxide, talc, silica, or zirconium oxide, with a clear plastic material, such as methacrylate resin, polycarbonate, or polyvinyl chloride. Illumination with light from the light diffusing plate 23 as described above is not too bright for a participant of the conference but is adequate for the participant to make a note during the conference.

The light from the light diffusing plate 23 is applied to the participant of the conference, and this exerts a positive impact on imaging by the camera main-body 30. As illustrated in FIGS. 6A and 6B, a mechanism that enables plane rotation of the light diffusing plate 23 is provided. Specifically, a true-circular stepped portion 24 is provided in a part of the main housing 11, and the disk-shaped light diffusing plate 23 is fitted to the stepped portion 24. By rotating the light diffusing plate 23, an air discharging direction or a light diffusing direction can be changed.

In the projector 1, a power source, drive circuits, and a drive section, such as a motor for automatically driving the camera or a motor for an air discharge fan, are provided in addition to the light source 12 serving as a heat source in FIG. 2. Heat generated by the heat sources need to be dissipated to the outside of the device. Therefore, the outlet 22 is arranged in a part of the wall of the main housing 11. It is desirable to provide a number of outlets in order to improve the heat dissipation efficiency. However, arrangement of the outlet 22 is limited by the size of the main housing 11 or by arrangement of components mounted inside the main housing 11. Therefore, it is difficult to provide a number of outlets. A position where the light diffusing plate 23 is arranged is also limited for the same reason as that of the outlet. In the device, a fan for discharging air or cooling a substrate is rotated, and wind noise from the fan may be picked up by a microphone that picks up voice in a video conference performed by the communication device for example, resulting in noise. The wind noise of the fan leaks from the outlet. Therefore, it is desirable to reduce the number of the outlets as many as possible.

In the embodiment, the light diffusing plate 23 having a heat dissipation function is provided on the outlet 22 arranged in the part of the main housing 11, so that the light diffusing plate 23 can function as a heat dissipating means. Therefore, it becomes not necessary to provide openings for the respective functions, enabling to reduce the size of the device or prevent noise. Besides, because the light from the light diffusing plate 23 is diffused, it is not necessary to provide a direction changing mechanism for changing an illumination direction. Therefore, the number of components can be reduced. As illustrated in FIG. 2, the diffused light from the light diffusing plate 23 is diffused and applied toward an opposite side (the optical axis is turned by 180 degrees) of the side where light is spread out in a direction corresponding to the surface of the screen, that is, the diffused light is diffused and applied toward an imaging region of the camera main-body 30. The camera main-body 30 captures a subject lighted by the illumination light.

As will be described later, in the case of the communication device that uses the projector of the embodiment to display an image for a video conference, image data captured by the camera main-body 30 is transmitted to a communication device including a projector at a remote place via a network, such as the Internet. The communication device that has received the image data at the remote place projects the image data onto a screen by using the projector that is installed in or connected to the communication device, or displays the image data on a monitor. For example, it is possible to conduct a video conference by causing a camera main-body of each of the communication devices to capture image data and causing a projector of each of the communication devices to project an enlarged image of the image data captured by the communication device of the other party onto a screen. In this way, the light from the light diffusing plate 23 is not a spot light but a diffused light. By using the diffused light, the camera main-body 30 can capture an image with reduced light flare.

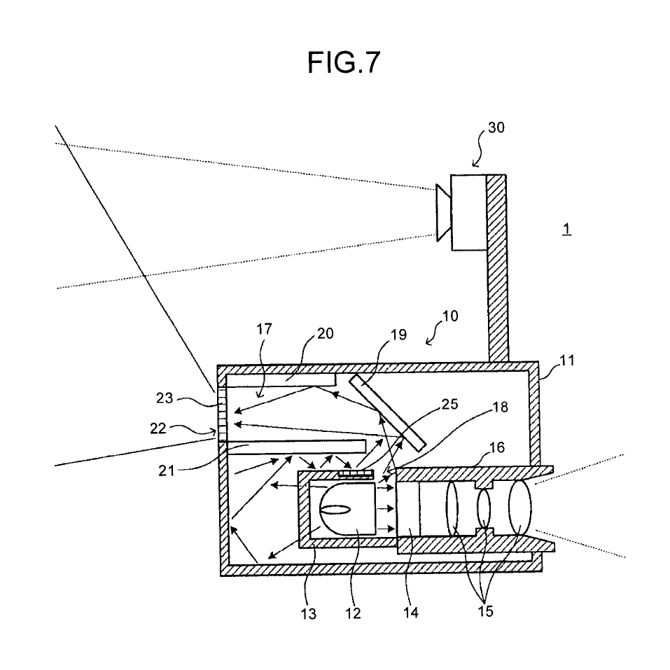

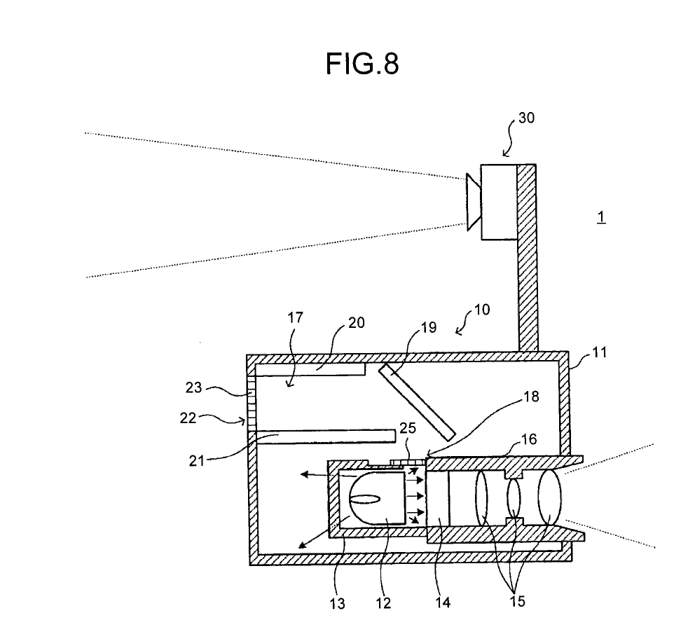

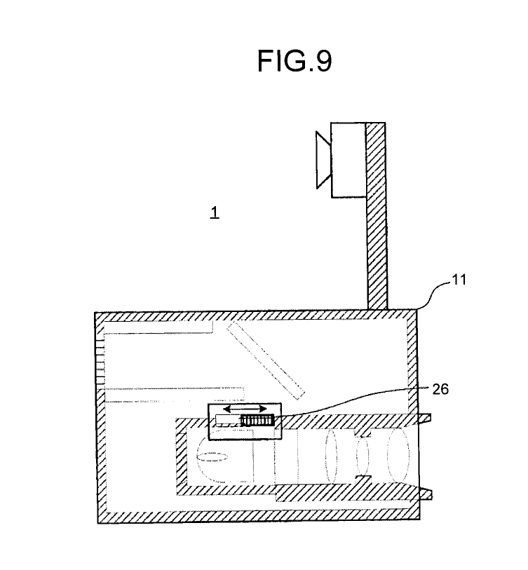

FIG. 7 and FIG. 8 are schematic cross-sectional views illustrating a modification of the configuration of the communication device provided with the projector function of the embodiment. FIG. 7 is a schematic cross-sectional view when a cap is open. FIG. 8 is a schematic cross-sectional view when the cap is closed. In the modification illustrated in FIG. 7 and FIG. 8, a cap 25 is provided for opening and closing the opening 18 arranged on the light source housing 13 that houses the light source 12 for the projector and that substantially blocks light. As illustrated in FIG. 7, the cap 25 is housed in a wall of the light source housing 13 when the opening 18 is opened. As illustrated in FIG. 8, when the opening 18 is closed by the cap 25, light from the light source 12 is blocked except that the reflected light or diffused light of the light that is not used for image data leaks from the connection section or the like of the housing member of the light source housing 13. Therefore, light from the light diffusing plate 23 attached to the outlet 22 is not diffused. As illustrated in FIG. 9, the cap 25 is connected to a handle 26 arranged on the outer side of the main housing 11. The cap 25 slides by sliding the handle 26 in the direction of an arrow in FIG. 9. Therefore, it becomes possible to diffuse light from the light diffusing plate 23 only when illumination is needed.

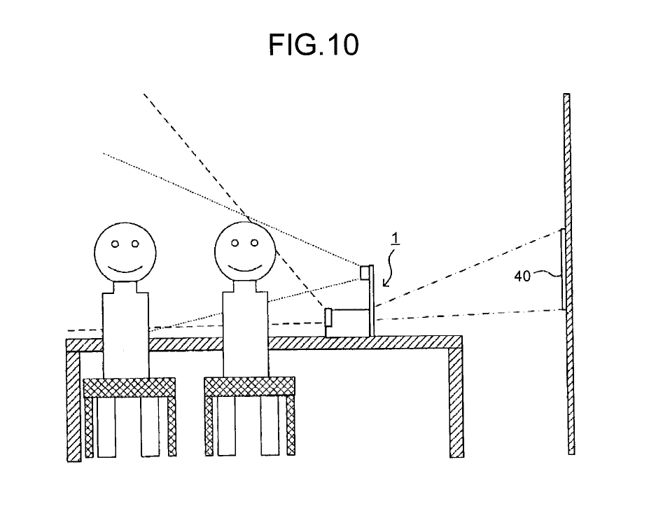

FIG. 10 is a schematic diagram illustrating a manner of use of the projector included in the communication device according to the embodiment. As illustrated in FIG. 10, the projector 1 projects an enlarged image onto a screen 40 mounted on a wall of a conference room or the like. The camera main-body installed in the projector 1 captures, for example, a scene of a conference involving participants of the conference. At this time, illumination light emitted by the light diffusing plate of the projector 1 is applied in a direction opposite to the screen 40 and lights the participants of the conference as illustrated in FIG. 10. In this way, because a side opposite to the screen 40 is illuminated, the darkness of the screen 40 side is maintained and the visibility of an enlarged projected image on the screen 40 can hardly be lowered. At the same time, the communication device can perform a video conference by using the electronic camera 2, the microphone 3, the speaker 4, and the like.

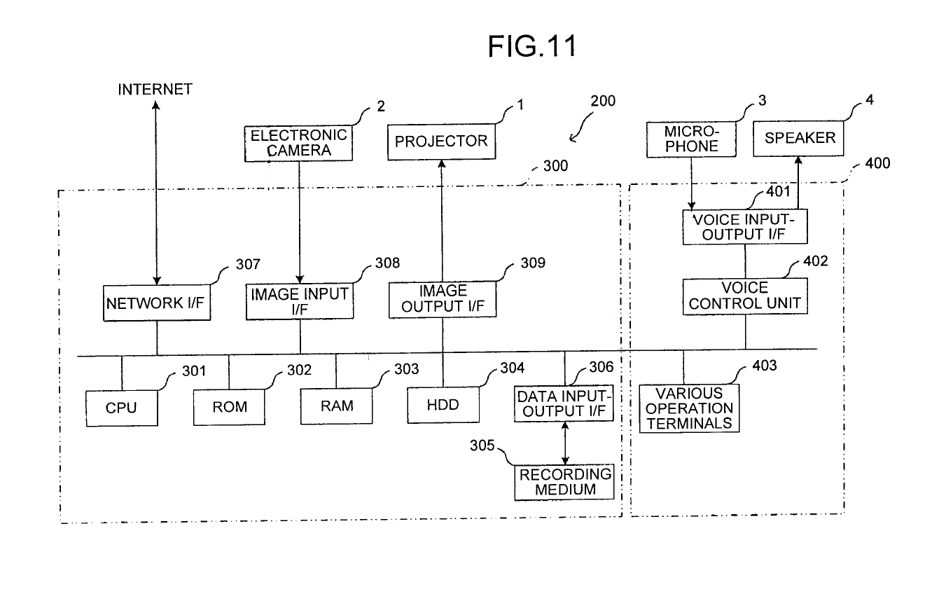

A case will be explained below that a video-conference device is used as an example of the communication device provided with the projector function of the embodiment. FIG. 11 is a block diagram illustrating a configuration of the video-conference device with the projector, when the video-conference device serves as a communication device.

A video-conference device 200 includes the projector 1, the electronic camera 2, the microphone 3, and the speaker 4 of the embodiment, and also includes a main control device 300 and a sub control device 400. The main control device 300 performs an encoding process or a decoding process on voice data and image data, and controls a bidirectional communication of voice and images via the Internet serving as a communication network. Specifically, as illustrated in FIG. 11, the main control device 300 includes a CPU 301, a ROM 302, a RAM 303, an HDD 304, a data input-output I/F 306, a network I/F 307, and an image input I/F 308. The data input-output I/F 306 performs data exchange with a recording medium 305. The network I/F 307 performs a bidirectional communication with the Internet. Components of an image output I/F 309 are connected via a bus line 310, such as an address bus or a data bus, such that a bidirectional communication can be enabled. The image data described above is data of a moving image or an intermittent image (a still image obtained at predetermined time intervals).

At an end portion of a main board provided in the main control device 300, an image input terminal, an image output terminal, and a LAN terminal, all of which serve as connectors, are mounted. A plurality of USB terminals are also mounted on the end portion of the main board. On a side surface of the housing of the video-conference device 200, a power supply jack is embedded. The power supply jack has three openings arranged at positions corresponding to the image input terminal, the image output terminal, and the LAN terminal, respectively, so that corresponding cables can be detachably attached via the openings corresponding to the respective terminals.

The CPU 301 illustrated in FIG. 11 controls the whole operations of the video-conference device based on a predetermined program (a video-conference device program). By a command issued by the CPU 301 according to the video-conference device program, a series of operations for a bidirectional communication of voice and images via the Internet is performed.

The ROM 302 stores therein a program, such as an IPL (Initial Program Loader), used to drive a CPU. The RAM 303 is used as a working area of the CPU 301. The HDD 304 stores therein the video-conference device program as described above, and various types of data, such as image data or voice data. For example, it may be possible to use an SSD (Solid State Drive) instead of the HDD. The video-conference device program may be distributed by being stored in a computer-readable recording medium, such as a recording medium, in a computer-installable or a computer-executable file format. The video-conference device program may be stored in the ROM 302 instead of the HDD 304. The HDD 304 controls read or write of various types of data with respect to the HDD 304 according to the control of the CPU 301.

The data input-output I/F 306 controls read or write (storage) of data with respect to the recording medium 305, such as a flash memory, connected to a USB terminal as described above. The data input-output I/F 306 controls transmission of data displayed on a display of a personal computer (PC) connected to one of the USB terminals to a destination video-conference device. The recording medium 305 is detachably attachable to the other USB terminals. The recording medium 305 is not limited to the flash memory as long as the recording medium 305 is a nonvolatile memory that enables read and write of data according to the control of the CPU 301. It may be possible to use an EEPROM (Electrically Erasable and Programmable ROM) or the like.

The network I/F 307 includes the LAN terminal (for example, an Ethernet (registered trademark) terminal) as described above, and inputs or outputs data (image data and voice data) via the Internet. The image input I/F 308 acquires, as predetermined image data, an image signal output by the electronic camera 2 that is a separate body. The network I/F 307 may be provided with a function to connect to a wireless LAN, without including the LAN terminal.

The image output I/F 309 outputs a menu screen of, for example, operation icons for selecting an address of a conference device of a party of a video conference, for adjusting image quality, or for selecting an output signal. The image output I/F 309 also outputs encoded image data among pieces of data received via the communication network, and image data input by the electronic camera 2. In this case, the image output I/F 309 converts the data into a predetermined analog or digital image signal that can be received by a display device, such as a liquid crystal monitor or a liquid crystal television, connected to the projector 1 or the image output terminal. The CPU 301 decodes the encoded image data by using a predetermined codec. Examples of the predetermined image signal include an analog RGB signal (VGA) and a component video signal. For another example, the predetermined image signal may be an HDMI (High-Definition Multimedia Interface) signal or a DVI (Digital Video Interactive) signal.

In the sub control device 400, various components, such as a plurality of operation terminals corresponding to a plurality of operation buttons to be described later, a voice input-output I/F 401, and a voice control unit 402 are mounted. A plurality of the voice control units 402 and various operation terminals 403 are communicably connected to one another via the bus line 310 such that a bidirectional communication can be enabled, and are also connected to the above-described components mounted on the main board of the main control device 300 such that a bidirectional communication can be enabled.

The voice input-output I/F 401 acquires, as predetermined voice data, a voice signal input by the microphone 3, and transmits the voice data to the voice control unit 402. The voice data received via the network I/F 307 and the voice control unit 402 is converted into a voice signal that can be reproduced by the speaker 4.

The voice control unit 402 adjusts the volume of voice output by the speaker 4 in accordance with an operation of a pair of volume buttons. The voice control unit 402 switches between input and non-input of voice by the microphone 3 in accordance with an operation of pressing down (ON/OFF) a microphone mute button.

The voice control unit 402 receives voice output by the speaker 4 via the microphone 3 when a bidirectional communication is performed with a destination video-conference device. The voice control unit 402 has an echo cancelling processing function to prevent echo or audio feedback that occurs due to sound wave loop generated with the destination video-conference device. For example, the voice control unit 402 has a noise cancelling processing function to reduce noise, such as operating noise of an air conditioner in a room or operating noise of a fan, input via the microphone 3.

An operating unit includes a plurality of operation buttons. The operation buttons include a lock release button, a power supply button, a line button, and a determination button. The power supply button turns on or off a power source of the video-conference device. The line button disconnects an Internet line to a communication destination. The determination button is used to determine an item selected on the menu screen displayed on a screen of a PC or a liquid crystal television (both of which are not illustrated) or displayed on a screen by the projector 1. Examples of the item selected and determined in the menu screen include an address of a video-conference device of a party of a video conference.

The projector 1 illustrated in FIG. 11 has the configuration as illustrated in FIG. 2, FIG. 7, and FIG. 8. Specifically, diffused light, reflected light, or transmitted light leaked from the light source 12 for the projector is guided to the light diffusing plate 23 via the reflector 19.

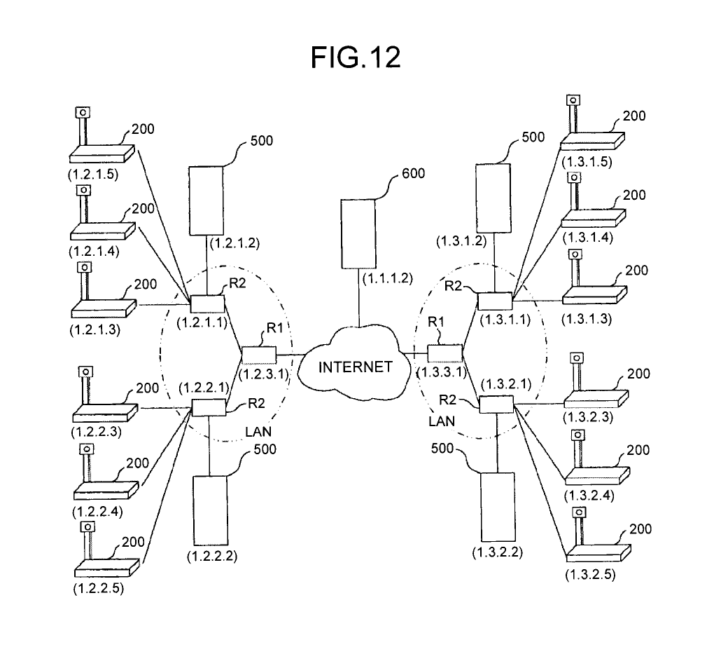

A conference system using the video-conference device will be explained below. FIG. 12 is a schematic diagram illustrating a configuration of the conference system using the video-conference device. As illustrated in FIG. 12, the conference system includes a plurality of (for example, two) routers R1 in the lowest level, a LAN (Local Area Network), the video-conference devices 200, relay devices 500, and a communication managing device 600. The routers R1 are connected to the Internet. The LAN is a communication network including a plurality of routers R2 each being connected to one of the routers R1. The video-conference devices 200 and the relay devices 500 are connected to the routers R2. The communication managing device 600 is connected to the Internet. The relay devices 500 are computers that realize various functions according to a predetermined control program. The relay devices 500 continuously monitor the quality (transmission rate) of the communication network and set image data with a resolution appropriate for the transmission rate. Specifically, the relay devices 500 continuously detect whether deviation (delay) occurs between image data and voice data in the video-conference devices 200 performing a bidirectional communication, due to the influence of the state of the communication network or the processing state of the video-conference devices 200.

When the deviation occurs between the voice data and the image data, the most optimal resolution is selected from among high-resolution image data, medium-resolution image data, and low-resolution image data, for the video-conference device 200 in which the deviation has occurred, and the selected image data is transmitted to the destination video-conference device 200. Therefore, even when the quality of the communication network is reduced, it is possible to continue to communicate a moving image without interruption. To eliminate the deviation between the image data and the voice data, the relay devices 500 can change not only the resolution but also a frame rate or both of a resolution and a frame rate to take a balance of the resolution and the frame rate. In this way, the relay devices 500 continuously monitor the quality (transmission rate) of the communication network and manage transmission of a moving image and voice by detecting deviation or designating a resolution.

The communication managing device 600 is a computer that manages all of the video-conference devices 200 according to a predetermined control program. The communication managing device 600 performs integral management in the following manner. The communication managing device 600 first recognizes current operating statuses (a bidirectional communication active state, a communication wait state, or an electrically non-conductive state) of all of the video-conference devices 200. The communication managing device 600 then performs device authentication of the video-conference devices 200, provides a destination list to the video-conference devices 200 authorized by the device authentication, selects the relay device 500, and charges for a bidirectional communication between the video-conference devices 200. The communication managing device 600 then manages the video-conference devices 200 and the relay devices 500.

The above explanation is given by way of example. The present invention has advantageous effects specific to aspects as described below.

Aspect 1

The light diffusing plate includes a plurality of the light diffusing members arranged with a gap interposed therebetween. In addition, the light diffusing plate is mounted on the outlet that dissipates heat generated in the device. Therefore, as described in the above embodiment, a thermal gas in the device passes through the gaps between the light diffusing members of the light diffusing plate 23, and incident light is diffused while being reflected by the surfaces of the light diffusing members in the gaps. The light diffusing plate configured as above is mounted on the outlet that is an opening arranged in a part of the device housing. Therefore, no opening is needed to mount the light diffusing plate except for the outlet. Consequently, no space is needed to open the opening in the device housing. As a result, it is possible to ensure a heat dissipation effect while reducing the size of the device.

Aspect 2

The cross section of the light diffusing member of Embodiment 1 is a triangle, a J-shaped, a T-shaped, or a parallelogram. Therefore, as explained in the embodiment, the light diffusing members are arranged so as to overlap each other on the optical path, so that a number of light diffusing surfaces can be obtained and a light diffusion function and a heat dissipation function can adequately be obtained.

Aspect 3

A mechanism that enables plane rotation of the light diffusing plate is provided in the configuration of Embodiment 1. Therefore, as explained in the embodiment, a member that serves both as a light diffusing member and an air discharging member can be rotated to change a light diffusing direction and an air discharging direction.

Aspect 4

A housing unit for housing an illuminating means is further provided in the configuration of Embodiment 1. The housing unit includes a cover that can be opened or closed from the outside of the device. Therefore, as explained in the modification of the embodiment, it is possible to diffuse light from the light diffusing plate 23 only when illumination is needed.

Aspect 5

An imaging means for acquiring an image of a subject lighted by the illuminating means and for outputting image data, and a communicating means for transmitting or receiving the image data via a communication network are further provided in the configuration of Embodiment 1. The device is connected to an image display device located at a remote place via the communicating means. Therefore, as explained in the embodiment, it is possible to use the projector as the video-conference device, enabling to enhance the usage of the projector.

Aspect 6

The projector of Embodiment 5 is used as the image display device that is located at a remote place and that is connected to the projector by the communicating means. Therefore, as explained in the embodiment, it is possible to use the projector as the video-conference device, enabling to enhance the usage of the projector.

According to an embodiment of the present invention, thermal gas in the device passes through the gaps between the light diffusing members of the light diffusing plates, and incident light is diffused while being reflected by surfaces of the light diffusing members in the gaps. The light diffusing plate configured as above is mounted on the outlet that is an opening arranged in a part of the device housing. Therefore, no opening is needed to mount the light diffusing plate except for the outlet. Consequently, no space is needed to open the opening in the device housing. As a result, it is possible to ensure a heat dissipation effect while reducing the size of the device, which is a unique advantageous effect.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projector comprising:
a projecting unit that generates an optical image by modulating light emitted from a light source according to image information and projects the optical image; and
an illuminating unit that guides a part of the light emitted from the light source to a light diffusing plate with use of an optical member so as to diffuse the light at the light diffusing plate for illumination, wherein
the light diffusing plate includes a plurality of light diffusing members arranged with a gap interposed between adjacent ones of the light diffusing members, and is mounted on an outlet that allows dissipation of heat generated in the projector.

2. The projector according to claim 1, wherein a cross section of each of the light diffusing members is one of a triangle, a J-shape, a T-shape, and a parallelogram.

3. The projector according to claim 1, further comprising a mechanism that enables plane rotation of the light diffusing plate.

4. The projector according to claim 1, further comprising a housing that houses the illuminating unit and that is provided with a cover that is opened or closed from an outside of the projector.

5. The projector according to claim 1, further comprising:
an imaging unit that acquires an image of a subject illuminated by the illuminating unit and outputs image data of the image; and
a communicating unit that transmits and receives the image data via a communication network, wherein
the projector is connected to an image display device at a remote place via the communicating unit.

6. The projector according to claim 5, wherein the projector is used for the image display device at a remote place connected by the communicating unit.
